(19) United States
(12) Patent Application Publication
(10) Pub. No.: US 2016/0339838 A1
(43) Pub. Date: Nov. 24, 2016

(54) Car Seat Alert

(71) Applicant: Ricardo Jose Diaz, North Providence, RI (US)

(72) Inventor: Ricardo Jose Diaz, North Providence, RI (US)

(21) Appl. No.: 14/718,093

(22) Filed: May 21, 2015

(51) Int. Cl. B60Q 9/00; B60N 2/00

(52) U.S. Cl. CPC B60Q 9/00; B60N 2/002

(57) ABSTRACT

The present invention provides a child car seat alert mechanism that includes weight sensors for determining the presence of a child in the car seat. The child car seat alert mechanism is installed in car whereby the weight sensors activate an indicator for informing a user that the child remains in the child car seat. The car seat alert mechanism whereby the weight sensors activate an indicator for informing a user that the child remains in the child car seat unbuckled and also the driver/passenger is alerted to a child exiting the child car seat after the engine has started. In one embodiment, the present invention provides a child car seat alert mechanism that reminds the driver of the vehicle that the vehicle has stopped and the child remains buckled in the child car seat.

### CROSS REFERENCE TO RELATED APPLIACTIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention is directed to a child car seat alert system. More particularly, the invention relates to an alert system that only activates when the belt buckle of a child car seat is buckled which is connected to weight sensors installed on the seat, and does not depend on the automobile for monitoring.

(2) Background

Six out of ten children who die in passenger vehicle crashes were unbelted, (National Safety Council, or NSC, 2002). According to the American Academy of Pediatrics, more children are killed as passengers in car crashes than from any other type of injury. One reason is that most children ride unbuckled or improperly restrained.

Children should be securely buckled in the proper type of child safety seat. Infants and toddlers should be secured in child safety seats and convertible rear facing and convertible forward-facing child safety from birth to four years of age. Children between about 40 to 80 lbs., and less than 4 feet 9 inches, tall should be secured in a booster seat so that the vehicle lap and shoulder belt fit them properly.

Children should not be left in an unattended vehicle. Left alone for only a few minutes, a small child can be abducted; set the vehicle in motion or even on a seemingly mild day may suffer a deadly heatstroke. In 2004, 35 children died of to heat stroke in the US after being left unattended in a parked car. Research has shown that when ambient temperatures rise above 35° C., sealed cars reach a suffocating 65° C. in just 15 minutes. Sunlight can heat car interiors to lethal temperatures in just 30 minutes, even if the weather is relatively cool. The researchers strongly urge parents not to leave children alone in parked cars, no matter how mild the weather. (New Scientist.com, July 2005)

Heat related deaths to young children in parked cars: an analysis of 171 fatalities in the United States, 1995-2002. (Join Together, Boston University School of Public Health, Boston, Mass., USA.) Results: A total of 171 fatalities that met the case criteria were identified. Twenty seven percent (46) were children who gained access to unlocked vehicles and 73% (125) were children who were left by adults. More than a quarter of the adults were aware they were leaving children in the vehicles, while half were unaware or forgot. Forty three percent of deaths to children who were left were associated with childcare that is 54 deaths-32 of those children were left by family members who intended to take them to childcare but forgot and went to work instead: 22 of those children were left by child care providers or drivers.

Accordingly, it is desirable to detect whether or not a child is in his or her safety seat, to detect whether or not the restraining buckle is secured, to detect the temperature and to detect whether or not the vehicle is in operation. Further, it is desirable to enable appropriate alarms if an unsafe condition is indicated. It is further desirable to provide a passive and wireless buckle-closure sensor,

Examples of prior art child safety seats includes inventions that describe an alarm that goes off if a child is left in a child seat when the engine goes oft Alarms are emitted from the child seat. Also some have described a system for detecting whether a person moves too far away from an infant in a car seat. The person carries a wireless alarm device that couples to the seat wirelessly. From the abstract: system and method uses a wireless tether comprising a transmitter and a receiver to alert a caregiver that an object or person has been left unattended. A detector senses the presence of the object, usually a child, located in a position such as a safety seat. The detector couples to the transmitter, which is, located near the object. The transmitter transmits at least one wireless signal when the object is in the position.”

There are systems that function “if the driver's door is open and the engine is turned off but there still is an occupant in the motor vehicle, an alarm is immediately triggered.” Further, “The occupancy alarm system may provide an interface and an override such that when the occupant remains in a potentially hazardous environment, that state is communicated via the interface and, if monitored by a responsible adult, the alarm can be overridden.

Various types of sensors have been incorporated into the buckle or tongue to sense when a buckle has been properly locked. These include optical, magnetic, electrical, for example, some have described a latch sensing seat belt buckle that uses magnetic flux. The described buckle includes a sensor and a magnet. The magnet is movable from a first position to a second position when a lockable element is inserted into the passage of the buckle. There are evidences of describing a child scar seat that enables an alarm if a vehicle door opens while the car seat is occupied.

Prior art discloses an infant alarm system for automobiles that sets of an alarm when the driver seat is unoccupied; the system has a pressure sensor pad for detecting the presence of a person in a car seat. The system also uses a belt buckle switch that determines whether a belt buckle is buckled to an infant car seat. The system also has a control box that is electrically connected to the pressure sensor pad and the belt buckle switch. The control box is for outputting an alarm signal when the belt buckle switch indicates that the belt buckle is buckled into the infant car seat and the pressure sensor pad does not detect the presence of the person in the car seat. The present invention is not analogous to such prior art, for it is a simple device that only depends on the child car seat belt buckle being buckled and will depend on weight sensors that will trigger an alert.

Studies and actual events have proven that infant and/or child safety seats should not be placed in the front seat of a vehicle, especially those equipped with a passenger side airbag. This of course has led to concerned parents placing their children in the rear seat of their vehicle. Given today's hectic schedule of two working parents, placing a child in the rear seat often times means out of sight, out of mind.

There have been a number of attempts to measure the weight of a seat occupant, all with significant disadvantages. For example load cells or strain gages have been used in a vehicle seat. One problem encountered in measuring the weight of a seat occupant is that the weight reading needs to be uniform when the vehicle is moving. When the vehicle travels around a curve or in a turn, the weight sensor cannot have a large change in its reading. In other words, the weight sensor needs to be somewhat insensitive to loads that are not in the vertical direction. The load cells of the prior art have suffered from giving false readings when subjected to side loads.

The present invention is a simple analogue or digital device that ensures that a guardian must unbuckle a child prior to walking a certain distance away from a vehicle and also the child is properly buckled before starting the ignition of the car. The present invention is an example of an analog or digital electronic device that operates through the engineering of the electrical components in the child car seat and in the warning device, leading to long-term reliability and affordability for everyone.

For the forgoing reasons there is a need of a child car seat system that will warn a guardian of a child that a child has been left unbuckled in the child car seat and such alert is simple to manufacture.

This invention is directed to an alert system used in-conjunction with a car seat buckle and weight sensors to alert when a child has been left inside a vehicle unbuckled and to ensure child safety when the guardian is driving by alert alerting the guardian to buckle child seat belt of the child before driving.

### SUMMARY OF THE INVENTION

A primary object of the present invention is to provide a child car seat alert mechanism that overcomes the shortcomings of the prior art.

Another object of the present invention is to provide a child car seat alert mechanism whereby the child car seat includes weight sensors for determining the presence of a child in the car seat.

Another object of the present invention is to provide a child car seat alert mechanism whereby the weight sensors activates an indicator for informing a user that the child remains in the child car seat.

Another object of the present invention is to provide a child car seat alert mechanism whereby the weight sensors activates an indicator for informing a user that the child remains in the child car seat unbuckled.

Another object of the present invention is to provide a child car seat alert mechanism whereby the driver/passenger is alerted to a child exiting the child car seat after the engine has started.

Another object of the present invention is to provide a child car seat alert mechanism that reminds the driver of the vehicle that the vehicle has stopped and the child remains buckled in the child car seat.

Another object of the present invention is to provide a child car seat alert mechanism including a plurality of indicators, positioned on at least one of an internal surface and an external surface of the vehicle.

Yet another object of the present invention is to provide a child car seat alert mechanism whereby the indicator is at least one of a tone, vibration, flashing or stable light, verbal communication and a combination thereof.

Yet another object of the present invention is to provide a child car seat alert mechanism that is simple and easy to use.

Still yet another object of the present invention is to provide a child car seat alert mechanism that is inexpensive to manufacture and operate.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

Other objects of the present invention will become apparent from time to time throughout the specification as hereinafter related.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a schematic view of the car seat alert system with both buckle and weight sensors, according to the preferred embodiment of the present invention.

FIG. 2 is a schematic view of the car seat alert system with vibration alert notification, according to the preferred embodiment of the present invention. etc.

### DETAILED DESCRIPTIONS OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide a seat alert system for alerting the driver that a baby is seated in the rear seat of the vehicle. The present invention has been described herein in respect to a child car seat and aims at alerting the driver that the child seat belt is unbuckled. However the inventive concepts described herein are applicable to all other seat occupants and the like.

Embodiments of the method are shown in the figures and discussed below, and it should be understood the operations as presented are exemplary and some operations may be substituted, added, rearranged or removed while still encompassing inventive subject matter. Moreover, it should be understood the order of operations is not to be limited unless explicitly specified herein.

Aspects of the present inventive subject matter are described with reference to the figure provided herein.

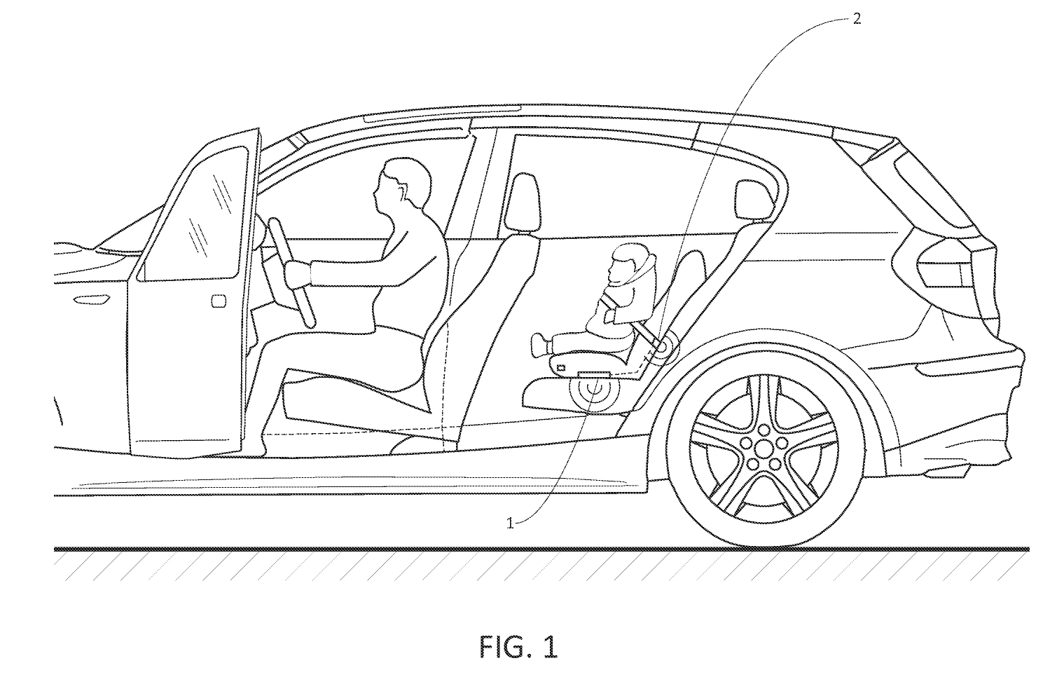

FIG. 1 depicts the car seat alert system, according to the preferred embodiment of the present invention.

Referring, to FIG. 1, there is shown a representative, the car seat alert system provided with weight sensors 1 attached to the seat and a buckle sensor 2 attached to a belt buckle, according to the present invention. As herein explained the present invention is a the car seat alert system which provides an instant alert to the driver depending upon the weight sensors installed in the rear child seat and so attached to the seat buckle that it can send an alert when the seat belt is buckled or unbuckled.

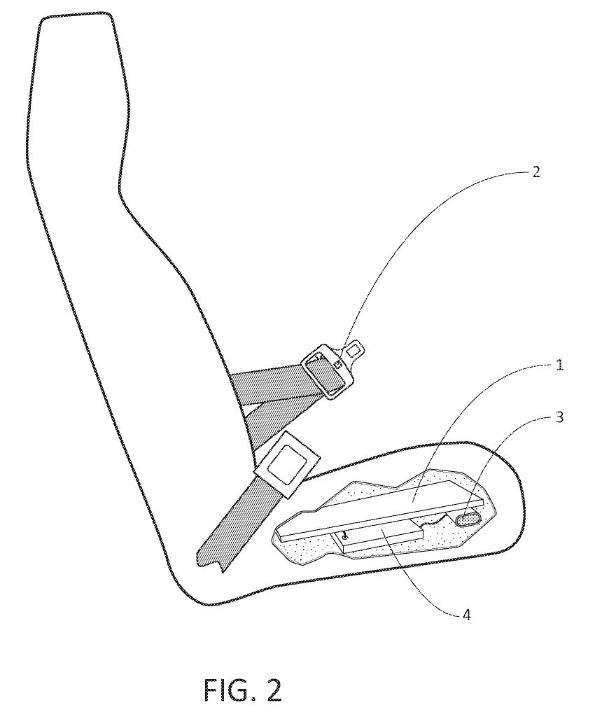

FIG. 2 is a schematic view of the car seat alert system with vibration alert notification, according to the preferred embodiment of the present invention.

Referring to FIG. 2, there is a shown the car seat alert system with vibration alert notification, according to the present invention. The vibration alert feature 3 will warn the driver about the child in the rear seat. There is a power source and power alert button that informs driver about the low power left in the power source. The power source used is the battery which is rechargeable in nature.

Accordingly the present invention provides a child car seat alert mechanism that overcomes the shortcomings of the known devices. The child car seat alert mechanism as discussed herein includes weight sensors for determining the presence of a child in the car seat. The said child car seat alert mechanism is installed whereby the weight sensors activate an indicator for informing a user that the child remains in the child car seat. The car seat alert mechanism whereby the weight sensors activate an indicator for informing a user that the child remains in the child car seat unbuckled and also the driver/passenger is alerted to a child exiting the child car seat after the engine has started.

In one embodiment, the present invention provides a child car seat alert mechanism that reminds the driver of the vehicle that the vehicle has stopped and the child remains buckled in the child car seat. There is a wireless communicating sensor connected to a buckle as shown in FIG. 2.

In another embodiment, the present invention provides, a child car seat alert mechanism including a plurality of indicators, positioned on at least one of an internal surface and an external surface of the vehicle.

In another embodiment of the current invention a battery 4 is provided to help in the functioning of the system. Also, the system in current invention will alert the driver about the state of the battery like battery is low on power. The car seat is provided with power to enable makes noise or alarm and vibrate in order to alert the driver.

In yet another embodiment, the present invention provides a child car seat alert mechanism whereby the indicator is at least one of a tone, vibration, flashing or stable light, verbal communication and a combination thereof.

Still yet another embodiment of the present invention provides a child car seat alert mechanism that is inexpensive to manufacture and operate.

It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components, operations and elements are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. An system for alerting the driver that a baby is seated in the rear seat of the vehicle comprising:
At least one weight sensor;
At least one buckle sensor;
A power source;
Notification means;
Wireless communicating means; and
A low battery indicator means.

2. The system of claim 1 further including a plurality of indicators alerting the driver that a baby is seated in the rear seat of the vehicle which positioned on at least one of an internal surface and an external surface of the vehicle.

3. The system of claim 1, wherein said notification means is a selected one of a tone, vibration, flashing or stable light, verbal communication and a combination thereof.

4. The system of claim 1, wherein said weight sensors activates an indicator for informing a user that the child remains in the child car seat.

5. The system of claim 1, wherein said weight sensors activating an indicator informing a driver that the child remains in the child car seat unbuckled.

6. The system of claim 1 alerting the driver/passenger about a child absence in the child car seat after the engine has started.

7. The system of claim 1 activating by the belt buckle of a child car seat connected to weight sensors installed on the seat.

8. The system of claim 1, wherein the power source is rechargeable battery.
